(19) United States
(12) Patent Application Publication
(10) Pub. No.: US 2023/0269301 A1
(43) Pub. Date: Aug. 24, 2023

(54) SYSTEM AND METHOD FOR PROVIDING ACCESSIBILITY OF FINANCIAL DOCUMENTS

(71) Applicant: Equisolve, Inc., Palm City, FL (US)

(72) Inventors: Thomas Runzo, Palm City, FL (US); Eric Mason, Palm City, FL (US)

(21) Appl. No.: 17/685,693

(22) Filed: Mar. 3, 2022

Related U.S. Application Data
(63) Continuation-in-part of application No. 17/675,735, filed on Feb. 18, 2022.

(51) Int. Cl. H04L 67/50; G06F 16/954; G06Q 40/04; H04L 65/1089

(52) U.S. Cl. CPC H04L 67/50; G06F 16/954; G06Q 40/04; H04L 65/1089

(57) ABSTRACT

A system for facilitating the provision of accessible financial documents over a communications network includes a web server for polling a regulatory agency to determine if it has published certain regulatory documents, downloading said regulatory documents, identifying inaccessible documents of the regulatory documents, generating a corresponding accessible document for each inaccessible document, storing the accessible documents, storing in a data structure a reference to each inaccessible document in association with a reference to a corresponding accessible, and at the same time the inaccessible SEC filing is made public, generating and publishing a web page that is publicly available over the communications network, wherein the web page includes a separate link to each of the regulatory documents, and a separate link the accessible documents, the web page formatted such that each link to an accessible document is written in association with a link to a corresponding regulatory document.

### CROSS-REFERENCE TO RELATED APPLICATIONS

This patent application is a continuation in part of, and claims priority to, patent application Ser. No. 17/675,735 filed Feb. 18, 2022, and titled “system and method for managing material non-public information for financial industry.” The subject matter of patent application Ser. No. 17/675,735 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to the field of financial technology and, more specifically, the claimed subject matter relates to the field of providing regulatory documents that are accessible to the disabled.

### BACKGROUND

The Securities and Exchange Commission (SEC) requires public companies, certain company insiders, and broker-dealers to file periodic financial statements and other disclosures, which are often referred to as SEC filings, SEC filing documents, or regulatory documents. Finance professionals and investors rely on SEC filings to make informed decisions when evaluating whether to invest in a company. SEC filings can be accessed for free on the SEC's website and the company's website, referred to as its Electronic Data Gathering, Analysis, and Retrieval system, otherwise known as EDGAR. The SEC selectively reviews the information it receives to monitor and enhance compliance. Investors study SEC filings to form a view of a company's performance and activities.

For the majority of consumers and investors, maneuvering through EDGAR and reading SEC filings is a relatively easy task. But for the 3 out of every 100 individuals that due to low vision, blindness, physical and cognitive disabilities, need to use screen readers and assistive technology, tasks like these can be problematic. One solution to this problem is the provision of accessible documents. An accessible document is a document created to be as easily readable by a sighted reader as a low vision, non-sighted reader, or those who require assistive technology. Making documents accessible allows individuals with low vision, blindness and disabilities to maneuver through, read and understand documents, and therefore have equal access to information that others take for granted.

One of the drawbacks associated with EDGAR, however, is that it does not do an adequate job of providing accessible documents. This is disadvantageous to the disabled as it does not provide them with equal access to the same information that is accessible to those without disabilities. The lack of accessible documents in the financial sector further disenfranchises a large segment of the population from participating in investment activities, which has long-ranging implications.

Therefore, what is needed is a system and method for improving the problems with the prior art, and more particularly for a more expedient and efficient method and system for facilitating the provision of regulatory documents that are accessible to the disabled.

### BRIEF SUMMARY

In one embodiment, a system for facilitating the provision of accessible financial documents over a communications network is disclosed. The system includes a web server communicably connected to the communications network, the webserver configured for polling a regulatory agency over the communications network to determine whether a plurality of regulatory documents associated with a particular company have been published by the regulatory agency, responsive to detecting that the regulatory agency has published said plurality of regulatory documents, downloading said plurality of regulatory documents from the regulatory agency over the communications network, wherein said plurality of regulatory documents are, identifying one or more inaccessible documents of the plurality of regulatory documents, generating a corresponding accessible document for each inaccessible document of the one or more inaccessible documents, thereby generating a plurality of accessible documents, and storing said plurality of accessible documents, for each inaccessible document of the one or more inaccessible documents, storing in a data structure a reference to said inaccessible document in association with a reference to a corresponding accessible document of the plurality of accessible documents, generating and publishing a web page that is publicly available over the communications network, wherein the web page includes a separate link to each of said plurality of regulatory documents, and a separate link to each of said plurality of accessible documents, wherein said web page is formatted such that each particular link to an accessible document is written in association with a particular link to a corresponding regulatory document, and wherein the web page is located on a web site of the particular company.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a system for facilitating the provision of accessible financial documents over a communications network, in accordance with one embodiment.

FIG. 2 is a block diagram showing the data flow of the process for providing accessible financial documents over a communications network, according to one embodiment.

FIG. 3A is a flow chart depicting the general control flow of a process for facilitating the provision of accessible financial documents over a communications network, according to one embodiment.

FIG. 3B is a flow chart depicting the general control flow of a specific portion of the process for facilitating the provision of accessible financial documents over a communications network, according to one embodiment.

FIG. 3C is a block diagram showing a web page generated during the process for facilitating the provision of accessible financial documents over a communications network, according to one embodiment.

FIG. 4 is a block diagram depicting a system including an example computing device and other computing devices.

### DETAILED DESCRIPTION

The disclosed embodiments improve upon the problems with the prior art by providing a system that allows for the quick and easy uploading, storing, and publishing of accessible Material Non-Public Information (MNPI) without allowing said MNPI to become compromised or publicly available before publication. The claimed embodiments are configured for the automatic detection of inaccessible documents or inaccessible portions of documents, and the automatic generation of accessible documents that correspond to said inaccessible documents or inaccessible portions of documents. Therefore, the disclosed embodiments reduce or eliminate instances where disabled users are not able to view important financial documents necessary to make financial decisions. This is advantageous for disabled users, as it provides greater access to trading markets and financial activities. An additional benefit of the disclosed embodiments is the immediate publication at the same time as the SEC filing is made public, the material financial information, is available in an accessible way, which reduces the need for human interaction in the publication process. The main benefit of the claimed subject matter is the improvement of the conventional process of publishing financial information, to the advantage of the disabled. The claimed subject matter further allows for the automation of the process of producing accessible versions of inaccessible documents, thereby resulting in a time savings.

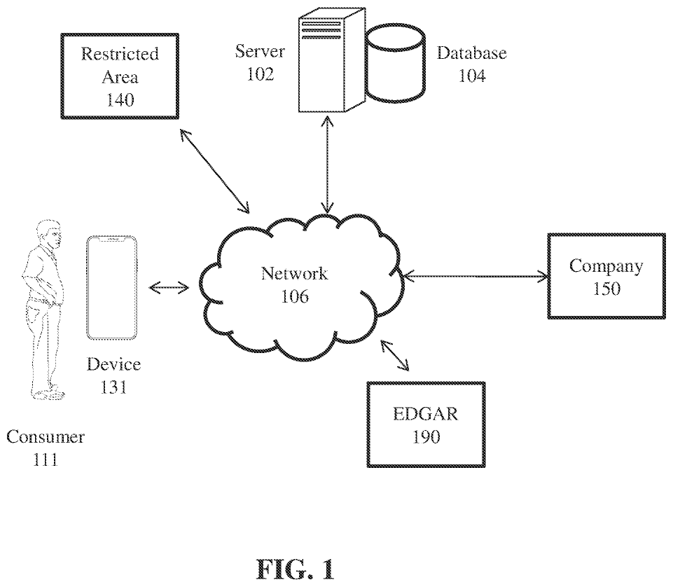

Referring now to the drawing figures in which like reference designators refer to like elements, there is shown in FIG. 1 an illustration of a block diagram showing the network architecture of a system 100 and method for facilitating the provision of accessible financial documents over a communications network in accordance with one embodiment. A prominent element of FIG. 1 is the server 102 associated with repository or database 104 and further communicatively coupled with network 106, which can be a circuit-switched network, such as the Public Service Telephone Network (PSTN), or a packet-switched network, such as the Internet or the World Wide Web, the global telephone network, a cellular network, a mobile communications network, or any combination of the above. Server 102 is a central controller or operator for the functionality of the disclosed embodiments, namely, facilitating the provision of accessible financial documents between users.

FIG. 1 includes computing devices 131, 140, 150, 190, which may be mobile computing devices such as smartphones, mobile phones, tablet computers, handheld computers, laptops, or the like. In another embodiment, computing devices 131, 140, 150, 190 may be stationary devices such as workstations, desktop computers, servers, laptops, all-in-one computers, or the like. In another embodiment, computing devices 131, 140, 150, 190 are AR or VR systems that may include display screens, headsets, heads-up displays, helmet-mounted display screens, or the like. Mobile computing device 131 corresponds to a consumer 111 of financial documents. Computing device 190 corresponds to the Securities and Exchange Commission's (SEC's) free online database, referred to as its Electronic Data Gathering, Analysis, and Retrieval system, otherwise known as EDGAR. Device 190 may also be a site, a collection of servers, or the like. Computing device 150 corresponds to a publicly-traded company or any company that is subject to financial regulations that require accessible documents for consumers. Device 150 may also be a site, a collection of servers or the like. Computing device 140 is described more fully below. Devices 131, 140, 150, 190 may be communicatively coupled with network 106 in a wired or wireless fashion.

FIG. 1 further shows that server 102 includes a database or repository 104, which may be a relational database comprising a Structured Query Language (SQL) database stored in a SQL server. Devices 131, 140, 150, 190 may also each include their own database. The repository 104 serves data from a database, which is a repository for data used by server 102 and devices 131, 140, 150, 190 during the course of operation of the disclosed embodiments. Database 104 may be distributed over one or more nodes or locations that are connected via network 106.

In one embodiment, device 140 may be a site, a collection of servers or the like. Specifically, in one embodiment, device 140 may be an overlay network which is a computer network that is layered on top of another network and is supported by its infrastructure. An overlay network decouples network services from the underlying infrastructure by encapsulating one packet inside of another packet. For this reason, accessing the overlay network requires special permissions, credentials, and specific software. Additionally, single-factor authentication or multi-factor authentication may be utilized to access the overlay network. In light of the above, device 140 is referred to as a restricted access area. Nodes in the overlay network are connected by virtual or logical links, each of which corresponds to a path through many physical links, in the underlying network. The Internet may be the basis for the overlay network, which may be constructed to permit the routing of messages to destinations not specified by an IP address. Distributed hash tables can be used to route messages to a node having a specific logical address whose IP address is not known in advance. In a different embodiment, device 140 is not a restricted access area as special permissions and credentials are not required.

Database 104 may include a user record for each user 111. A user record may include: contact/identifying information for the user (name, address, telephone number(s), email address, etc.), information pertaining to documents associated with the user, information pertaining to the documents viewed by the user etc. A user record may also include a unique identifier for each user, the current location of each user (based on location-based services from the user's mobile computer), and a description of the user's disability. A user record may further include demographic data for each user, such as age, sex, income data, race, color, marital status, etc.

The database 104 may include a company record for each company 150. A company record may include: contact/identifying information for the company (name, address, telephone number(s), email address, website etc.), the company ticker symbol, information pertaining to documents associated with the company, etc. A company record may also include a unique identifier for each company and a description of past documents issued by said company.

Database 104 may include a record for each document. A document comprises a collection of information that is stored in electronic form in a particular format on a storage device. In one embodiment, database 104 is used to hold SEC filing documents. Examples of documents referred to as SEC filings are a registrations statement, form 10-K, form 10-Q, form 8-K, proxy statement, forms 3, 4, and 5, schedule 13D, form 144, and foreign investment disclosures.

A registration statement provides information about the securities being offered by a company as well as its financial condition. A Form 10-K is an annual report that provides a comprehensive analysis of the company's financial condition. A Form 10-Q is a truncated version of a Form 10-K that is filed quarterly. The form provides a view of the company's ongoing financial condition throughout the year. A Form 8-K is what a company uses to disclose major developments that occur between filings of the Form 10-K or form 10-Q. Major company events that would necessitate the filing of a Form 8-K include bankruptcies or receiverships, material impairments, completion of acquisition or disposition of assets, or departures or appointments of executives. A proxy statement discloses the salaries of the management of a company and any other perks that a company's management is eligible for. The proxy statement is presented prior to the shareholder meeting and must be filed with the SEC before soliciting a shareholder vote on the election of directors and approval of other corporate actions. Forms 3, 4, and 5 disclose ownership amounts of company directors and officers, changes in ownership, and an annual summary. Schedule 13D is a beneficial ownership report and is required when any owner acquires 5% or more of the voting shares in a company. Form 144 is required when corporate insiders want to dispose of company stock. Form 144 is a notice of the intent to sell restricted stock, typically acquired by insiders or affiliates in a transaction not involving a public offering. Foreign investment disclosures apply to foreign companies offering securities in the U.S. market.

Said record for each document may include permissions. Document-level permissions are used to manage access to various pieces of content based on a user's or team's attributes. A user or team may be allowed or denied access to certain documents. Tied with the concept of document permissions is the concept of material nonpublic information (or MNPI). MNPI is data relating to a company (such as company 150) that has not been made public but could have an impact on its share price. It is against the law for holders of MNPI to use the information to their advantage in trading stocks. It is also illegal to share MNPI with others who use it to profit in the market. One of the objects of the claimed subject matter is the ability to manage MNPI in such a way that it is disclosed to the public all at once, and that said disclosure even includes disclosure to the disabled in an accessible manner using accessible documents.

FIG. 1 shows an embodiment wherein networked computing devices 131, 140, 150, 190 interact with server 102 and repository 104 over the network 106. It should be noted that although FIG. 1 shows only the networked computers 131, 140, 150, 190, the system of the disclosed embodiments supports any number of networked computing devices connected via network 106. Further, server 102 and units 131, 140, 150, 190 include program logic such as computer programs, mobile applications, executable files or computer instructions (including computer source code, scripting language code, or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 131, 140, 150, 190. Further, server 102 and its functionality, according to a preferred embodiment, can be realized in a centralized fashion in one computer system or in a distributed fashion wherein different elements are spread across several interconnected computer systems.

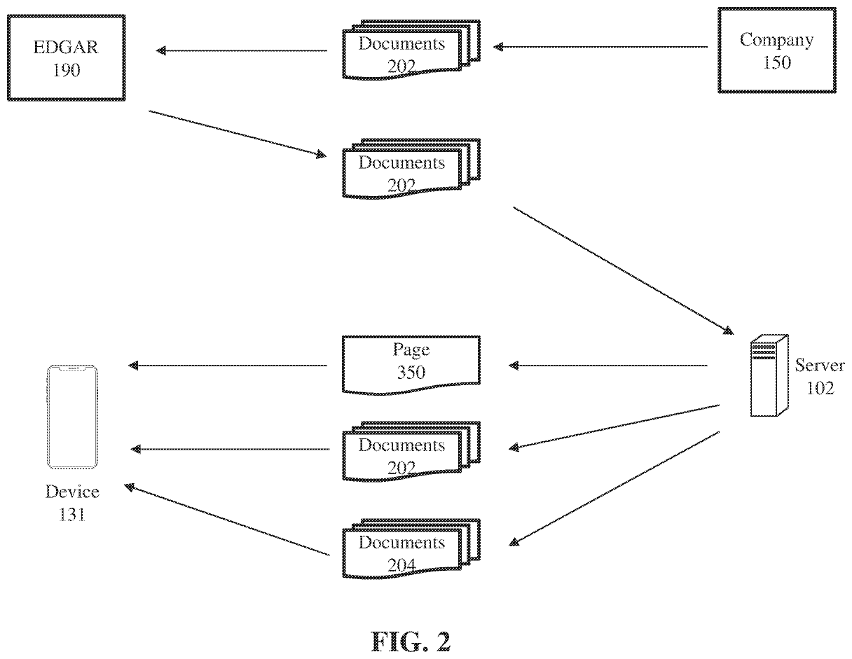

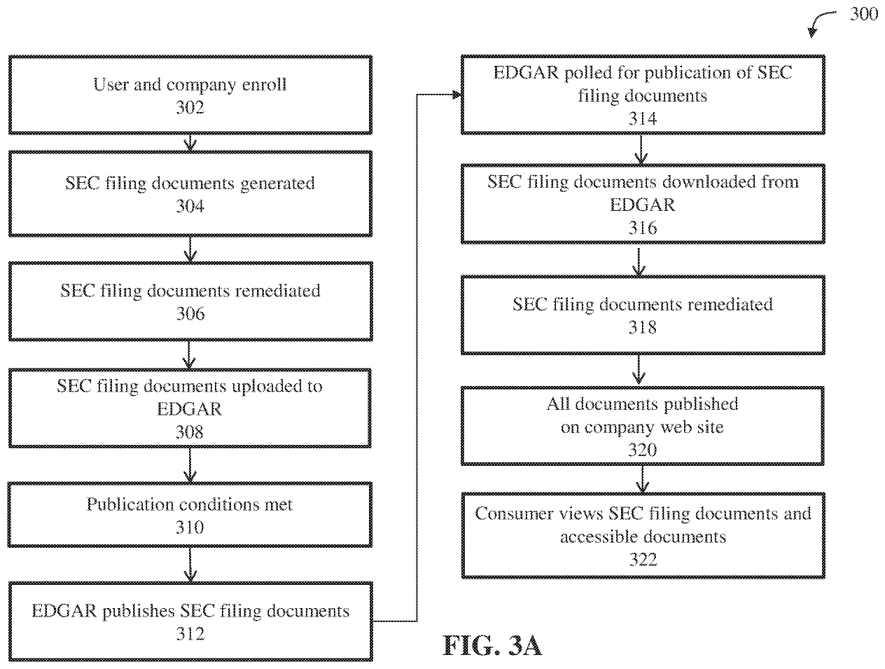

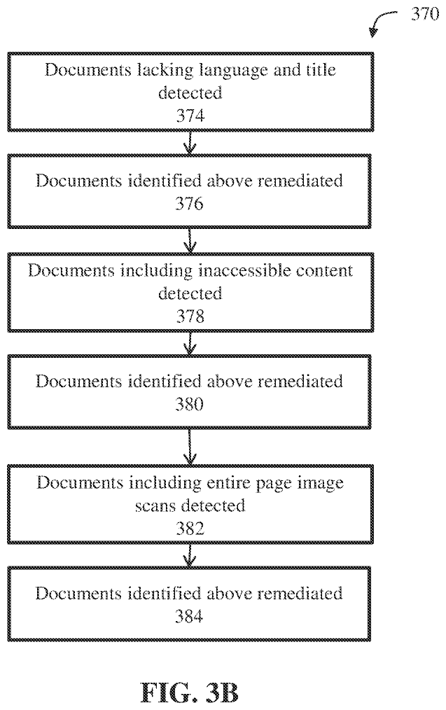

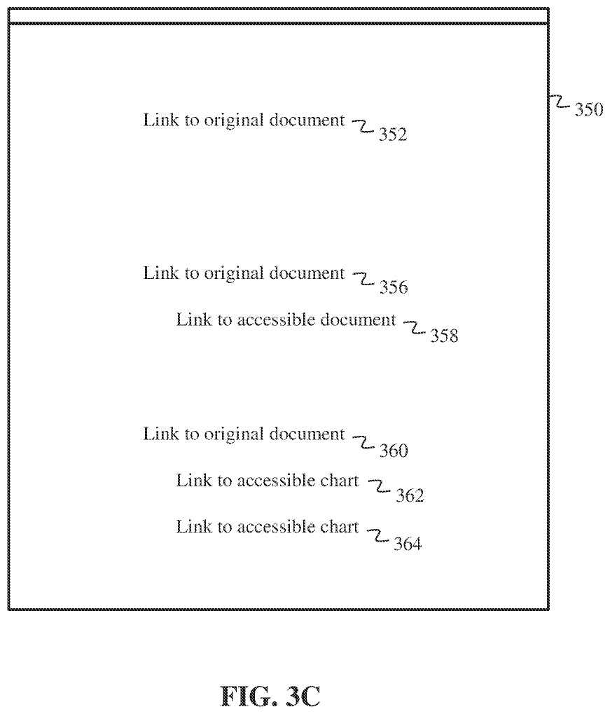

The process of facilitating the provision of accessible financial documents over a communications network will now be described with reference to FIGS. 2-3C below. FIGS. 2-3C depict the data flow and control flow of the process for facilitating the provision of accessible financial documents over a communications network 106, according to one embodiment. The process of the disclosed embodiments begins with optional step 302 (see flowchart 300), wherein consumer 111 and company 150 may enroll or register with server 102. In the course of enrolling or registering, the users may enter data into their device by manually entering data into an application, a web browser, or a mobile application via keypad, touchpad, or via voice. In the course of enrolling or registering, the user and/or company may enter any data that may be stored in a user record or a company record, as defined above. Also, in the course of enrolling or registering, server 102 may generate a user record for each registering user and store the user record in an attached database, such as database 104, and server 102 may generate a company record for each registering company and store the company record.

Subsequently, in step 304, company 150 generates its SEC filing documents 202. In one embodiment, said SEC filing documents 202 comprise a plurality of documents. Subsequently, in optional step 306, server 102 or company 150 detects and remediates one or more of its SEC filing documents 202. This process is described below in greater detail below with respect to FIG. 3B. That is, embedded in step 306 is the execution of steps for detecting inaccessible content in one or more of its SEC filing documents 202, and for creating accessible documents 204 corresponding to said inaccessible documents, as described more fully in steps 374-384 below. In step 308, server 102 and/or the company uploads or transmits its SEC filing documents 202 to EDGAR 190.

Subsequently, the conditions for publication of the SEC filing documents 202 are met in step 310. In one embodiment, the conditions for publication comprises the arrival of a predefined time and date, at which time said documents are slated to become public. In step 312, EDGAR 190 makes the SEC filing documents 202 public and publishes the SEC filing documents 202 on its site.

Then, in step 314, the server 102 or company 150 continuously polls EDGAR 190 to determine whether EDGAR has published said SEC filing documents 202. In one embodiment, said polling process comprises periodically transmitting a request to EDGAR for data regarding the company associated with the SEC filing documents 202 and reading the response received from EDGAR. Specifically, the polling process comprises periodically transmitting a request to EDGAR requesting whether the SEC filing documents 202 for the specific company (150) have been published, and reading the response received from EDGAR to determine if said response states that the SEC filing documents 202 for the specific company (150) have been published. In one example, the periodic request (and response) is an HTTP request (and response) or an API request or call to an Application Programming Interface (and response) used by EDGAR to distribute data about data it publishes. Said request can be made using a CIK number to specifically identify the company 150. A Central Index Key or CIK number is a number given to an individual, company, or foreign government by the United States Securities and Exchange Commission. The number is used to identify its filings in several online databases, including EDGAR. The numbers are up to ten digits in length. In another embodiment, said polling process comprises using a web feed, a JSON feed or an RSS feed that allows users to access updates about EDGAR's publications in a standardized, computer-readable format. Also, in step 314, server 102 or company 150 detects, using its polling process, that EDGAR has published said SEC filing documents 202. Specifically, said detecting process comprises reading the response received from EDGAR to determine if said response states that the SEC filing documents 202 for the specific company (150) have been published.

In step 316, the publishing entity (which may be server 102 or company 150) copies or downloads the SEC filing documents 202 from EDGAR 190. Next, in step 318, server 102 or company 150 processes the SEC filing documents 202 and remediates the same, thereby generating accessible documents 204. This process is described below in greater detail below with respect to FIG. 3B. That is, embedded in step 318 is the execution of steps for detecting inaccessible content in one or more of its SEC filing documents 202, and for creating accessible documents 204 corresponding to said inaccessible documents, as described more fully in steps 374-384 below.

In step 320, the publishing entity (which may be server 102 or company 150) publishes the SEC filing documents 202, as well as the accessible documents 204, on the company 150 site. The SEC filing documents 202 may be published by providing a link on a company website that references the location (via a URL) of the SEC filing documents 202 uploaded to EDGAR in step 308. In another embodiment, the SEC filing documents 202 may be published by uploading the full documents on the company website such that they are directly downloadable from said company website. The publishing entity may be server 102, company 150, or another entity acting on behalf of company 150, such as a website hosting entity or a third-party content management system. Also in step 320, the restricted access area 140 is configured to remove restricted access, such that the data stored in the restricted access area 140 is freely available via the Internet without any necessary permissions or special software. In one embodiment, the process of publishing any information on the web site of company 150 encompasses the acts of logging on to a website hosting server (which may be operated by a third-party hosting entity) using credentials provided by the company and uploading relevant information (such as web pages, code and other software) to said web site hosting server.

In step 320, server 102 or company 150 generates a web page 350 (see FIG. 3C) that provides a series of links for viewing the SEC documents 202 and the accessible documents 204, according to the data structure described with reference to FIG. 3B below. In said page 350, each link for viewing a particular SEC document is immediately followed by a link to one or more accessible documents that correspond to said particular SEC document, and/or is immediately followed by a link to one or more accessible documents that pertain to inaccessible content within said particular SEC document. In a different embodiment, in said page 350, each link for viewing a particular SEC document includes within it a link to one or more accessible documents that correspond to said particular SEC document, and/or a link to one or more accessible documents that pertain to inaccessible content within said particular SEC document. In this embodiment, the link is a URL and the link is clickable and readable in the viewing area of the SEC document when said document is viewed using a document viewer, such as a word processor or a portable document format viewer.

In one embodiment, step 320 operates as follows. Server 102 or company 150 iterates through the SEC filing documents 202, and for each particular SEC filing document, server 102 or company 150 writes a link to said particular SEC filing document in web page 350 (such as links 352, 356, 360). Also, during the iteration through the SEC filing documents 202, server 102 or company 150 searches the data structure (described with reference to FIG. 3B below) for a reference to said particular SEC filing document. If server 102 or company 150 identifies a reference to the particular SEC filing document in the data structure, then the particular document is inaccessible or has content that is inaccessible. Subsequently, the server or company 150 searches the data structure for an accessible document that corresponds to the particular SEC filing document. Then, under the link (written above) to said particular SEC filing document, server 102 or company 150 writes a link in the web page 350 to the accessible document that corresponds to said particular SEC filing document. For example, in FIG. 3C, it can be seen that underneath link 356 to an original SEC filing document, there is a link 358 to an accessible document that corresponds to the original SEC filing document. In another example, in FIG. 3C, it can be seen that underneath link 360 to an original SEC filing document, there is a link 362 to an accessible document that corresponds to inaccessible content within the original SEC filing document, and there is another link 364 to another accessible document that corresponds to inaccessible content within the original SEC filing document. Therefore, the data structure created and populated in steps 374-382 below is utilized in step 320 during the generation of the web page 350. The data structure is utilized in step 320 to determine how web page 350 will be written and formatted.

In step 324, consumer 111 utilizes his computing device 131 to access web page 350, including SEC filing documents 202 and corresponding accessible documents 204.

Note that in one embodiment, the publication process of step 320 happens almost instantaneously upon EDGAR publishing the SEC filing documents 202 in step 312, thereby making step 320 occur in real time. Real-time describes operations in computing or related processes that guarantee occurrences within a specified time, usually a relatively short time. In this case, the real-time process of step 320 happens so quickly (in relation to step 312), that in time scales detectable by humans, step 320 effectively occurs at the same time as step 312. This is because step 320 happens so quickly (in relation to step 312), that a person would perceive step 320 as occurring at the same time as step 312. This is advantageous because regulations require that inaccessible documents 202 (published in step 312) are published at the same time as the accessible documents 204 (published in step 320) so as not to give the non-disabled investor an advantage over the disabled investor. Additionally, it is important to note that the SEC filing documents 202 and corresponding accessible documents 204 are published at the same time in step 320. Again, this is advantageous due to regulations that require inaccessible documents 202 be published at the same time as accessible documents 204. In one embodiment, a tolerable limit for the time frame between the publication of documents in step 312 and the publication of documents in step 320 is from about 6 to about 20 milliseconds.

FIG. 3B is a flow chart 370 depicting more detail on step 306 and/or step 318 of the process for facilitating the provision of accessible financial documents over a communications network, according to one embodiment.

The process of step 306 and/or step 318, wherein the SEC filing documents 202 are remediated and corresponding accessible documents 204 are generated, begins with step 374, wherein server 102 or company 150 scans the SEC filing documents 202 and detects that one or more of said documents do not have a language (such as English or Spanish) specified, and/or that a title for the document is not specified. This causes a problem because a screen-reader and assistive technology requires that a document specifies both a language, as well as a title for a document in order for the screen reader and assistive technology to operate properly. A screen reader and assistive technology is a technology that helps people who have difficulties seeing to access and interact with digital content, like websites or documents. The main users of screen readers and assistive technology are people who are blind, have very limited vision, or other disabilities. If a screen reader or assistive technology cannot work properly, the SEC filing document is not accessible to people with sight disorders or other disabilities. In this example, server 102 or company 150 stores in a data structure (such as an array) a unique identifier for the SEC filing document, such as a document file name. The file name may be stored as a text field. In one embodiment, the unique identifier data are stored in an array element within an array.

In step 376, for any SEC filing document where the server 102 or company 150 detected that the document does not have a language (such as English or Spanish) specified, and/or that a title for the document is not specified, the server 102 or company 150 creates an accessible document 204 that corresponds to the inaccessible SEC filing document, wherein the accessible document 204 has had English added as the language and an appropriate title it added to the document. In this step, server 102 or company 150 scans the document identified as not accessible, identifies text in the document that corresponds to a title, and the server creates a corresponding accessible document with said title.

Next, in step 378, server 102 or company 150 processes or scans the SEC filing documents 202 to identify inaccessible documents, portions of documents, or content within documents. For example, in step 378, server 102 or company 150 may identify, within an SEC filing document, content (such as images, pictures, clip art, charts, tables, shapes, infographics, embedded objects, inked entries, signatures, video, or audio files, etc.) that is not accessible to persons with sight disorders. In this example, server 102 or company 150 stores in a data structure (such as an array) the position of said content, as well as a unique identifier for the SEC filing document, such as a document file name. The position may be stored as a numerical value that represents the location of said content within the SEC filing document and the file name may be stored as a text field. In one embodiment, the position data and the unique identifier data are stored in an array element within an array.

In one embodiment, a document may be deemed as containing content not accessible to persons with sight disorders because it lacks alternative text or alt text. Alt text is the written copy that appears in place of an image on a webpage if the image fails to load on a user's screen. Alt text helps screen-reading and assistive technology tools describe images to visually impaired readers. The server 102 or company 150 may also scan the SEC filing document for image scans of written content or content including text. In this example, server 102 or company 150 stores in a data structure (such as an array) the position of said content, as well as a unique identifier for the SEC filing document, such as a document file name. The position may be stored as a numerical value that represents the location of said content within the SEC filing document and the file name may be stored as a text field. In one embodiment, the position data and the unique identifier data are stored in an array element within an array.

Then, in step 380, server 102 or company 150 creates accessible documents 204 that correspond to the inaccessible documents, portions of documents, or content within documents that were identified in step 378. For each image, picture, clip art, chart, table, shape, embedded object, inked entry, signature, video, or audio file that was identified as not accessible in step 378, the document is remediated by the server by adding alt text, closed captions, transcripts and correcting tagging, thereby creating a corresponding accessible document. An accessible document may include document properties that cater to the disabled, alternative text corresponding to visual content, styles that cater to the disabled, easily readable column headers and row headers in charts and tables, proper spacing between lines or paragraphs, closed captions for audio files, and accessibility disclaimers throughout the document. An accessible document 204 that corresponds to the inaccessible SEC filing document may comprise an accessible document 204 has had alt text added to the document. In one embodiment, server 102 or company 150 scans the document identified as not accessible in step 378, identifies content in the document that lacks alt text, and the server automatically opens a ticket (in a ticketing system) that prompts a service individual to add the alt text as needed. Subsequently, server 102 creates a corresponding accessible document with said alt text.

A ticketing system is a software package that manages and maintains lists of issues that require attention by a service individual. When a ticket is opened, this prompts a service individual to log on to the system, read the ticket request and act accordingly. In this case, for each ticket that is opened, a client service individual logs on to the system, reviews a piece of content that lacks alt text, and then enters alt text that corresponds to said content.

In step 380, server 102 or company 150 also stores, in the data structure, a unique identifier for the accessible document, such as a document file name, in association with the file name of the SEC filing document to which the accessible document pertains. That is, in the data structure, the accessible document file name is associated with the SEC filing document file name. In one embodiment, the accessible document file name is stored in the same array element as the array element that holds the SEC filing document file name and position data. In another embodiment, the accessible document file name is stored in the same array element as the array element that holds the SEC filing document file name.

In step 382, server 102 or company 150 may detect that an entire SEC filing document is not accessible to people with sight, physical or cognitive disorders because it may be, for example, a full-page scan comprising an image file (such as a JPEG or a PNG) representing text but with no searchable or alt text. In this example, server 102 or company 150 stores in the data structure a unique identifier for the document, such as a document file name. In one embodiment, the unique identifier data are stored in an array element within an array.

In step 384, server 102 or company 150 creates an accessible document 204 that corresponds to the inaccessible SEC filing document, wherein the accessible document 204 has had text added to the document that corresponds to the text in the image scans. In this step, server 102 or company 150 scans the document identified as not accessible in step 382, identifies image scans of written content or content including text, and the server will either automatically perform Optical Character Recognition (OCR) of said image scans, thereby producing actual text that corresponds to the text in the image scans or routes the document to be paired up with an accessible version of the document. Subsequently, server 102 or company 150 creates a corresponding accessible document with said actual text included in the document, thereby remediating the image scans. An image scan is an image, such as a JPEG or PNG image, that includes text in said image, wherein said text is not searchable. Screen readers and assistive technology cannot read the text in an image scan and therefore said text in an image scan must be remediated to make the text readable to screen readers and assistive technology. In one embodiment of step 384, server 102 or company 150 obtains (directly from the company 150) an accessible document 204 that corresponds to the inaccessible SEC filing document, wherein the accessible document 204 includes text that corresponds to the text in the image scans.

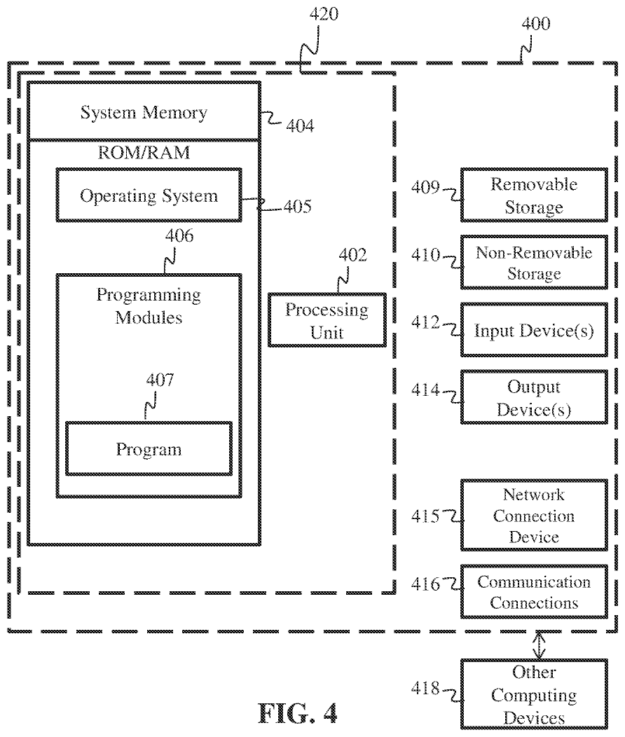

FIG. 4 is a block diagram of a system including an example computing device 400 and other computing devices. Consistent with the embodiments described herein, the aforementioned actions performed by 102, 131, 140, 150, 190 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random-access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of 131, 140, 150, 190, 102. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer-readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general-purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for facilitating the provision of accessible financial documents over a communications network, the system comprising:
a web server communicably connected to the communications network, the webserver configured for:
polling a regulatory agency over the communications network to determine whether a plurality of regulatory documents associated with a particular company have been published by the regulatory agency;
responsive to detecting that the regulatory agency has published said plurality of regulatory documents, downloading said plurality of regulatory documents from the regulatory agency over the communications network, wherein said plurality of regulatory documents are;
identifying one or more inaccessible documents of the plurality of regulatory documents;
generating a corresponding accessible document for each inaccessible document of the one or more inaccessible documents, thereby generating a plurality of accessible documents, and storing said plurality of accessible documents;
for each inaccessible document of the one or more inaccessible documents, storing in a data structure a reference to said inaccessible document in association with a reference to a corresponding accessible document of the plurality of accessible documents;
generating and publishing a web page that is publicly available over the communications network, wherein the web page includes a separate link to each of said plurality of regulatory documents, and a separate link to each of said plurality of accessible documents, wherein said web page is formatted such that each particular link to an accessible document is written in association with a particular link to a corresponding regulatory document, and wherein the web page is located on a web site of the particular company.

2. The system of claim 1, wherein the data structure comprises an array.

3. The system of claim 2, wherein a link comprises a hypertext link.

4. The system of claim 3, wherein a link comprises a uniform resource locator.

5. The system of claim 4, wherein the time period between the step of detecting that the regulatory agency has published said plurality of regulatory documents and the step of generating and publishing a web page is between 6 milliseconds and 20 milliseconds.

6. A system for facilitating the provision of accessible financial documents over a communications network, the system comprising:
a web server communicably connected to the communications network, the webserver configured for:
receiving a plurality of regulatory documents associated with a particular company;
identifying a first subset of documents of the plurality of regulatory documents that are inaccessible;
generating a corresponding accessible document for each document of the first subset of documents, thereby generating a first plurality of accessible documents, and storing said first plurality of accessible documents;
for each document of the first subset of documents, storing in a data structure a reference to said document in association with a reference to a corresponding accessible document of the plurality of accessible documents;
polling a regulatory agency over the communications network to determine whether the plurality of regulatory documents associated with the particular company have been published by the regulatory agency;
responsive to detecting that the regulatory agency has published said plurality of regulatory documents, downloading said plurality of regulatory documents from the regulatory agency over the communications network;
identifying a second subset of documents of the plurality of regulatory documents that are inaccessible;
generating a corresponding accessible document for each document of the second subset of documents, thereby generating a second plurality of accessible documents, and storing said second plurality of accessible documents;
for each document of the second subset of documents, storing in a data structure a reference to said document in association with a reference to a corresponding accessible document of the plurality of accessible documents;
generating and publishing a web page that is publicly available over the communications network, wherein the web page includes a separate link to each of said plurality of regulatory documents, and a separate link to each of said first and second plurality of accessible documents, wherein said web page is formatted such that each particular link to an accessible document is written in association with a particular link to a corresponding regulatory document, and wherein the web page is located on a web site of the particular company.

7. The system of claim 6, wherein the data structure comprises an array.

8. The system of claim 7, wherein a link comprises a hypertext link.

9. The system of claim 8, wherein a link comprises a uniform resource locator.

10. The system of claim 9, wherein the time period between the step of detecting that the regulatory agency has published said plurality of regulatory documents and the step of generating and publishing a web page is between 6 milliseconds and 20 milliseconds.

11. A system for facilitating the provision of accessible financial documents over a communications network, the system comprising:
a web server communicably connected to the communications network, the webserver configured for:
polling a regulatory agency over the communications network to determine whether a regulatory document associated with a particular company has been published by the regulatory agency;
responsive to detecting that the regulatory agency has published said regulatory document, downloading said regulatory document from the regulatory agency over the communications network;
identifying portions of the regulatory document that are inaccessible due to lack of alt text;
creating a ticket in a ticketing system for each of the portions of the regulatory document that are inaccessible due to lack of alt text, wherein each ticket requests alt text for said portions;
reading alt text that has been input by a service individual for each of the portions of the regulatory document that are inaccessible due to lack of alt text;
generating an accessible document corresponding to the regulatory document, wherein said accessible document includes the alt text that has been input by the service individual for each of the portions of the regulatory document and storing said accessible document;
storing in a data structure a reference to said regulatory document in association with a reference to the accessible document;
generating and publishing a web page that is publicly available over the communications network, wherein the web page includes a link to the regulatory document, and wherein the regulatory document contains a separate link to the accessible document, and wherein the web page is located on a website of the particular company.

12. The system of claim 11, wherein the data structure comprises an array.

13. The system of claim 12, wherein a link comprises a hypertext link.

14. The system of claim 13, wherein a link comprises a uniform resource locator.

15. The system of claim 14, wherein the time period between the step of detecting that the regulatory agency has published said regulatory document and the step of generating and publishing a web page is between 6 milliseconds and 20 milliseconds.
